(19) United States
(12) Patent Application Publication
(10) Pub. No.: US 2026/0135134 A1
(43) Pub. Date: May 14, 2026

(54) APPARATUS FOR MANUFACTURING BATTERY CELL

(71) Applicant: SK ON CO., LTD., Seoul (KR)

(72) Inventors: Hyeong Gyu KIM, Daejeon (KR); Hyung Gi KIM, Daejeon (KR); Sang Jun PARK, Daejeon (KR)

(21) Appl. No.: 19/370,781

(22) Filed: Oct. 28, 2025

(30) Foreign Application Priority Data
Nov. 11, 2024 (KR) 10-2024-0159191

(51) Int. Cl. H01M 10/04; H01M 50/105

(52) U.S. Cl. CPC H01M 10/0404; H01M 10/0481; H01M 10/049; H01M 50/105

(57) ABSTRACT

An apparatus for manufacturing a battery cell in which an electrode assembly includes a pressurizing portion disposed on both sides of the battery cell and pressurizing the battery cell, and a heating unit disposed on both sides of the battery cell and sealing the opening of the outer casing. The pressurizing portion includes a first pressurizing portion disposed on one side of the battery cell and a second pressurizing portion disposed on the other side of the battery cell. Each of the first pressurizing portion and the second pressurizing portion includes a first plate configured to pressurize an accommodation portion in which an electrode assembly is accommodated in the battery cell, and a second plate configured to pressurize a gas chamber in which gas is accommodated in the battery cell.

### CROSS-REFERENCE TO RELATED APPLICATION(S)

This patent document claims the priority and benefits of Korean Patent Application No. 10-2024-0159191 filed on November 11, 2024, the disclosure of which is incorporated herein by reference in its entirety.

### TECHNICAL FIELD

The disclosure and implementations disclosed in this patent document generally relate to an apparatus for manufacturing a battery cell.

### BACKGROUND

Battery cells are secondary batteries installed in vehicles and other applications, and unlike primary batteries, may be charged and discharged, making them suitable for a wide range of applications, including digital cameras, mobile phones, laptops, and hybrid vehicles. Examples of secondary batteries include nickel-cadmium batteries, nickel-metal hydride batteries, nickel-hydrogen batteries, lithium secondary batteries, and the like.

Depending on the shape of the outer casing, these secondary batteries may be categorized into can-type battery cells, where the electrode assembly is housed in a metal can, and pouch-type secondary batteries, where the electrode assembly is housed in a pouch, such as an aluminum laminate sheet.

Pouch-type secondary batteries are manufactured by enclosing the electrode assembly within a pouch-shaped outer casing, injecting an electrolyte, and sealing the inlet.

### SUMMARY

The present disclosure can be implemented in some embodiments to provide an apparatus for manufacturing a battery cell, which facilitates the sealing of a pouch during the battery cell manufacturing process.

Battery cells manufactured using the manufacturing apparatus in the present disclosure may be widely applied in green technology fields such as electric vehicles, battery charging stations, and other battery-powered solar and wind power generation. Furthermore, the battery cells may be used in eco-friendly electric vehicles and hybrid vehicles, which aim to prevent climate change by reducing air pollution and greenhouse gas emissions.

In some embodiments of the present disclosure, an apparatus for manufacturing a battery cell in which an electrode assembly is inserted into an outer casing in a pouch form having an opening formed therein, includes a pressurizing portion disposed on both sides of the battery cell and pressurizing the battery cell, and a heating unit disposed on both sides of the battery cell and sealing the opening of the outer casing. The pressurizing portion includes a first pressurizing portion disposed on one side of the battery cell and a second pressurizing portion disposed on the other side of the battery cell. Each of the first pressurizing portion and the second pressurizing portion includes a first plate configured to pressurize an accommodation portion in which an electrode assembly is accommodated in the battery cell, and a second plate configured to pressurize a gas chamber in which gas is accommodated in the battery cell.

In an embodiment, the first plate and the second plate may be interconnected and move together.

In an embodiment, each of the first pressurizing portion and the second pressurizing portion may be disposed such that the second plate protrudes further toward the battery cell than the first plate.

In an embodiment, at least one of the first pressurizing portion and the second pressurizing portion may include a position adjusting portion connecting the first plate and the second plate, and the position adjusting portion may adjust a protrusion distance of the second plate, relative to the first plate.

In an embodiment, the position adjusting portion may include a first bracket extending from the first plate, a shaft rotatably coupled to the first bracket, and a second bracket extending from the second plate and coupled to the shaft.

In an embodiment, the second bracket may include an insertion groove into which the shaft is inserted, and a depth of the insertion groove may be configured to be greater than a diameter of the shaft.

In an embodiment, the apparatus for manufacturing a battery cell may further include an adjustment member disposed to protrude from the first bracket toward the second plate and supporting the second plate.

In an embodiment, the adjustment member may be screw-coupled to the first bracket, below the shaft, and a protrusion distance thereof from the first bracket may be adjusted by screw rotation.

In an embodiment, each of the first pressurizing portion and the second pressurizing portion may be configured such that, when moving toward the battery cell, the first plate contacts the battery cell prior to the second plate.

In an embodiment, the heating unit may include a pair of heating blocks positioned on both sides of an opening of the battery cell, respectively, and configured to heat pressurize the outer casing.

In an embodiment, the pressurizing portion may be provided as a plurality of pressurizing portions positioned in parallel, and the apparatus for manufacturing a battery cell may further include a moving portion moving the plurality of pressurizing portions together.

In an embodiment, the moving portion may include a first frame coupled to a plurality of first pressurizing portions, a second frame coupled to a plurality of second pressurizing portions, and a power device reciprocally moving the first frame and the second frame.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is an exploded perspective view of the battery cell illustrated in FIG. 1.

FIG. 3 is a perspective view schematically illustrating the state of the battery cell of FIG. 1 before removing the gas chamber during a manufacturing process thereof.

FIG. 4 is a side view schematically illustrating an apparatus for manufacturing a battery cell according to an embodiment.

FIG. 5 is a perspective view of the apparatus for manufacturing a battery cell illustrated in FIG. 4.

FIGS. 6A and 6B are views illustrating the adjustment of the position of a second plate in a pressurizing portion illustrated in FIG. 4.

FIGS. 7 to 9 are views illustrating a process of sealing a battery cell using the apparatus for manufacturing a battery cell illustrated in FIG. 4.

FIGS. 10 and 11 are views illustrating an apparatus for manufacturing a battery cell according to another embodiment.

### DETAILED DESCRIPTION

Features of the present disclosure disclosed in this patent document are described by example embodiments with reference to the accompanying drawings.

Hereinafter, the present disclosure will be described in detail with reference to the attached drawings. However, these are merely illustrative and the present disclosure is not limited to the detailed embodiments illustrated herein.

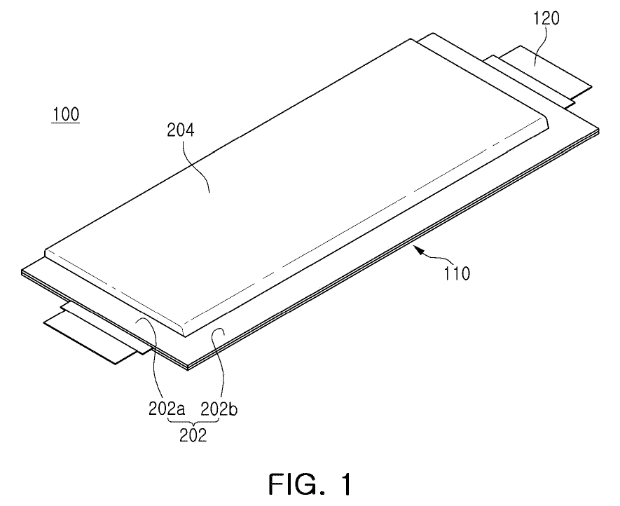

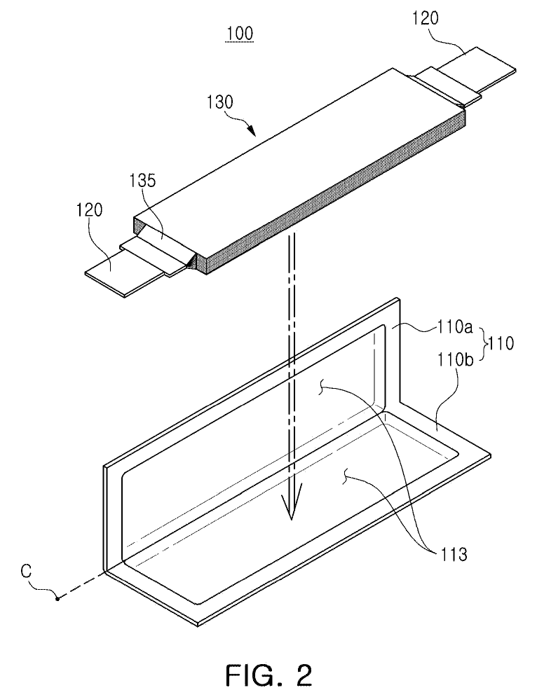

FIG. 1 is a perspective view of a battery cell according to an embodiment, and FIG. 2 is an exploded perspective view of the battery cell illustrated in FIG. 1.

Referring to FIGS. 1 and 2, a battery cell 100 according to an embodiment may include an electrode assembly 130 and a case 110 housing the electrode assembly.

The battery cell 100 according to the present embodiment is a rechargeable battery and may include a lithium-ion (Li-ion) battery or a nickel metal hydride (Ni-MH) battery. A nickel metal hydride battery is a battery cell using nickel as the cathode, a hydrogen-storing alloy as the anode, and an alkaline aqueous solution as the electrolyte, and may be used as an energy source for electric vehicles (EVs), hybrid electric vehicles (HEVs), or the like due to high capacity per unit volume thereof, as well as in various fields such as energy storage.

The electrode assembly 130 is a member including multiple electrodes stacked in a roughly hexahedral shape and may be housed in the accommodation space 113 of the case 110 along with an electrolyte.

The case 110 may be formed of a flexible film material. For example, the case 110 may be formed of a material in which the surface of a metal thin film, including aluminum, is insulated.

The case 110 may have an accommodation space 113 provided therein to accommodate the electrode assembly 130. Furthermore, an electrode lead 120 may be protruded and disposed on the outside of the case 110.

As illustrated in FIG. 2, the battery cell 100 of the present embodiment may be formed by folding a single sheet of outer material and then bonding three sides together to seal the accommodation space 113. Accordingly, the case 110 of the present embodiment may be divided into a first case 110a and a second case 110b based on the fold line C along which the outer material is folded.

In detail, the battery cell 100 of the present embodiment may be manufactured by forming an accommodation space 113 in the outer material through press processing or the like, accommodating the electrode assembly 130 in the accommodation space 113, folding the outer material along the fold line C, and then bonding the edges where the first case 110a and the second case 110b meet to seal the accommodation space 113. While a heat-sealing method may be used as the edge bonding method, the present disclosure is not limited thereto.

Hereinafter, the portion where the electrode assembly 130 is housed is referred to as an accommodation portion 204, and the edge portion where the outer casing is joined is referred to as the sealing portion 202. According to the manufacturing method described above, the sealing portion 202 may not be disposed on the edge at which the outer casing is folded along the fold line C in the battery cell 100 of the present embodiment.

In the present embodiment, the sealing portion 202 may be divided into a first sealing portion 202a formed in the portion where the electrode lead 120 is disposed, and a second sealing portion 202b formed in the portion where the electrode lead 120 is not disposed.

Meanwhile, the battery cell 100 of the present embodiment may have an accommodation space 113 in each of the first case 110a and the second case 110b. However, the configuration of the present disclosure is not limited thereto, and various modifications are possible, such as providing an accommodation space 113 in only one of the first case 110a and the second case 110b.

Furthermore, an electrode tab 135 may be disposed between the electrode assembly 130 and the sealing portion 202. The electrode tab 135 may electrically connect the electrode assembly 130 and the electrode lead 120, and multiple electrode tabs 135 may extend from the electrode assembly 130 and be joined to at least one electrode lead 120.

The electrode lead 120 may include a cathode lead and an anode lead. At least portions of the electrode leads 120 protrude outwardly of the case 110, and the electrode assembly 130 may be electrically connected to external elements via the electrode leads 120.

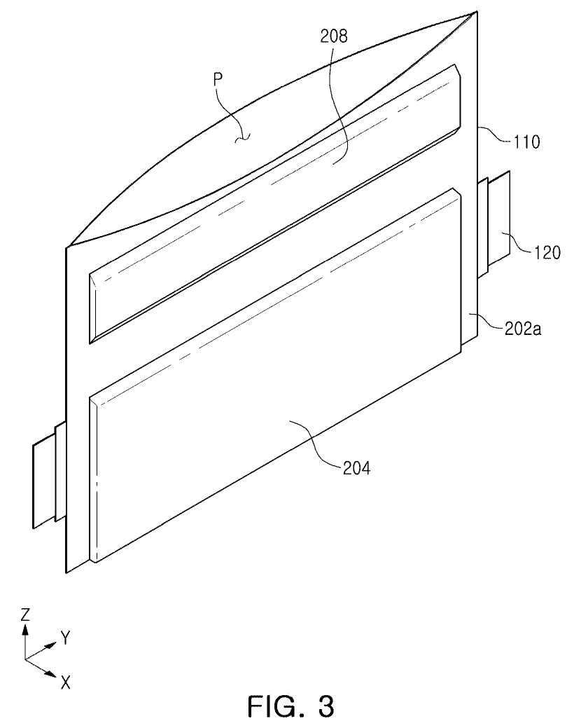

FIG. 3 is a perspective view schematically illustrating the state of the battery cell of FIG. 1 before the gas chamber is removed during the manufacturing process.

Referring to FIG. 3, in a process in which the aforementioned pouch-type battery cell 100 is manufactured, as illustrated in FIG. 2, an accommodation portion 204 where the electrode assembly 130 is disposed, and a gas chamber 208 where gas generated from the accommodation portion 204 is collected, may be formed within the case 110 of the pouch shape. In this case, the gas chamber 208 is a space that accommodates gas generated during the manufacturing process of the battery cell 100 and may be a portion that is ultimately removed after all gas has been removed.

In more detail, a battery cell manufacturing method of the present embodiment may include a first sealing process in which the electrode assembly 130 is housed in an outer casing, and then the outer casing is partially sealed to form a pouch with an opening P, a process in which an electrolyte is inserted into a pouch-shaped case 110 through the opening P, and a second sealing process in which the opening P is sealed.

When forming the case 110 by folding a single sheet of outer casing as in the present embodiment, the first sealing process may be a process in which the first sealing portion 202a described above is formed.

Additionally, the battery cell manufacturing method of the present embodiment may further include, after the second sealing process, a degassing process in which charging and discharging are performed by connecting power to the electrode assembly 130, and gas generated within the accommodation portion 204 during the charging and discharging process is collected into a gas chamber 208 and removed, a third sealing process of sealing the space between the gas chamber 208 and the accommodation portion 204, and a process of removing the gas chamber 208.

The apparatus for manufacturing a battery cell of the present embodiment may be a device used in the second sealing process, which is the process of sealing the opening P.

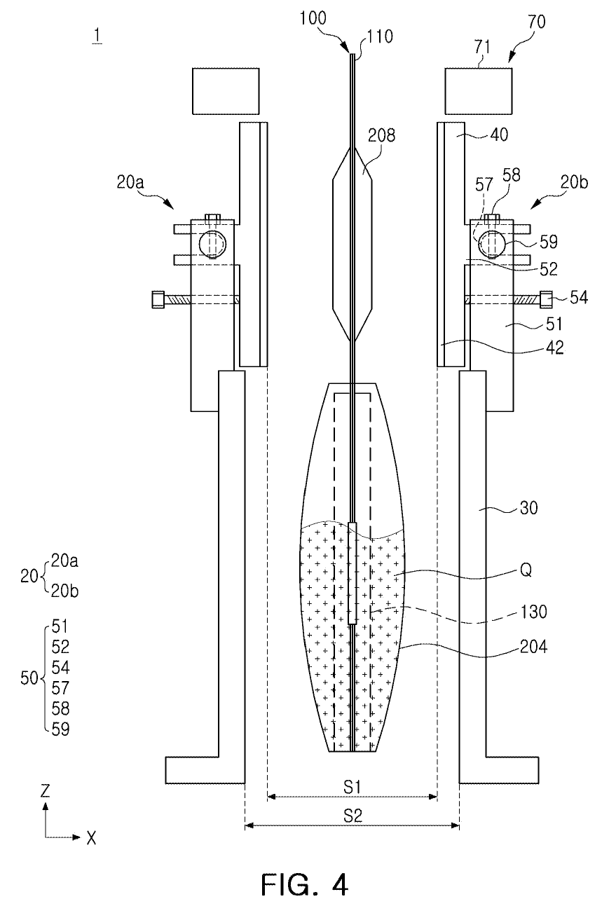

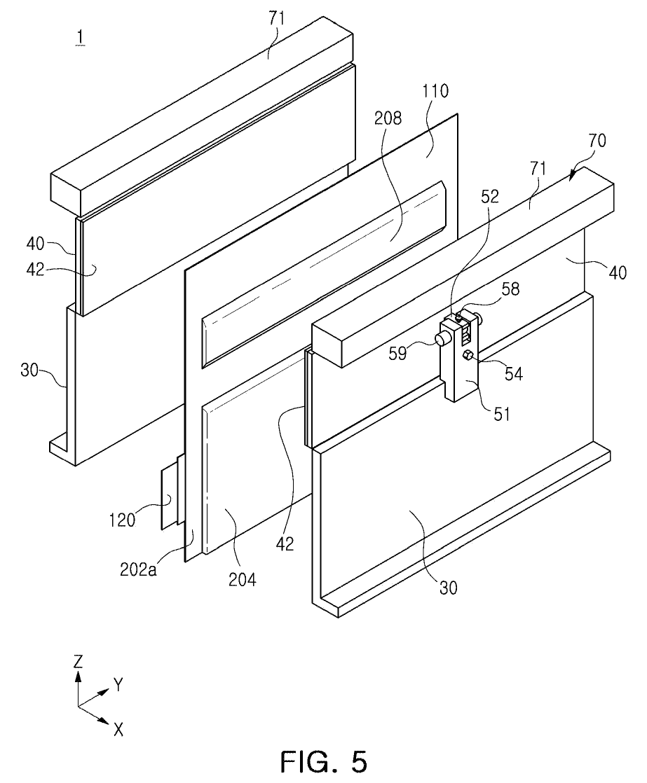

FIG. 4 is a side view schematically illustrating an apparatus for manufacturing a battery cell according to an embodiment, and FIG. 5 is a perspective view of the apparatus for manufacturing a battery cell illustrated in FIG. 4.

Referring to FIGS. 4 and 5 together, an apparatus 1 for manufacturing a battery cell according to an embodiment may be used in a process of sealing an opening (P in FIG. 3) of a case 110 after inserting an electrode assembly 130 and an electrolyte Q into the case 110 during the process of manufacturing the battery cell.

The apparatus 1 for manufacturing a battery cell of the present embodiment is a device for manufacturing a battery cell 100 in which an electrode assembly 130 is inserted into a pouch-shaped outer casing having an opening P formed therein, and may include a pressurizing portion 20 disposed on both sides of the battery cell 100 to pressurize the battery cell 100, and a heating unit 70 disposed on both sides of the battery cell 100 to seal the opening P of the outer casing.

In an embodiment, the pressurizing portion 20 includes a first pressurizing portion 20a disposed on one side of the battery cell 100 and a second pressurizing portion 20b disposed on the other side of the battery cell 100. Each of the first pressurizing portion 20a and the second pressurizing portion 20b may include a first plate 30 that pressurizes an accommodation portion 204 in which an electrode assembly 130 is accommodated in the battery cell 100 and a second plate 40 that pressurizes a gas chamber 208 in which gas is accommodated in the battery cell 100.

The pressurizing portion 20 may pressurize the battery cell 100 by moving linearly along a first direction. In this case, the first direction may be a thickness direction of the battery cell 100, and may be the X-axis direction with reference to FIG. 5. To this end, the pressurizing portion 20 of the present embodiment may include a pair of first plates 30 respectively disposed on opposite sides of the accommodation portion 204 of the battery cell 100 in the first direction, and a pair of second plates 40 disposed on opposite sides of the gas chamber 208, respectively.

The pair of first plates 30 may be disposed spaced apart from each other to be parallel to each other, and the accommodation portion 204 of the battery cell 100 may be disposed between the pair of first plates 30.

The pair of first plates 30 may pressurize the accommodation portion 204 of the battery cell 100. To this end, each first plate 30 may be disposed to face the widest surface of the accommodation portion 204 among the surfaces forming the accommodation portion 204, and may be disposed to be reciprocally movable toward the battery cell 100. In an embodiment, the first plate 30 may be formed to face the entire wide surface of the accommodation portion 204. Therefore, when the first plate 30 contacts the accommodation portion 204, the entire wide surface of the accommodation portion 204 may contact the first plate 30.

The first plate 30 may be formed as a block or plate that has rigidity that does not deform or break during the process of pressurizing the accommodation portion 204.

The second plate 40 may pressurize the gas chamber 208 of the battery cell 100. To this end, each second plate 40 may be disposed to face the wide surface of the gas chamber 208 of the battery cell 100 and may be disposed to be reciprocally movable toward the battery cell 100. In an embodiment, the second plate 40 may be formed to face the entire wide surface of the gas chamber 208. Therefore, when the second plate 40 contacts the gas chamber 208, the entire wide surface of the gas chamber 208 may contact the second plate 40.

The second plate 40 may be interconnected with the first plate 30 and move together with the first plate 30. In an embodiment, a pair of second plates 40 may be coupled to a pair of first plates 30, respectively.

Additionally, the pressurizing portion 20 of the present embodiment may include a first pressurizing portion 20a disposed on one side of the battery cell 100 and a second pressurizing portion 20b disposed on the other side of the battery cell 100. The first pressurizing portion 20a and the second pressurizing portion 20b may each include a first plate 30 and a second plate 40, and may be disposed to be line-symmetric with respect to the outer casing.

The battery cell 100 of the present embodiment may have an accommodation portion 204 formed to be thicker than the gas chamber 208. Correspondingly, the respective second plates 40 of the first pressurizing portion 20a and the second pressurizing portion 20b may be disposed to protrude further toward the battery cell 100 than the first plates 30.

The apparatus 1 for manufacturing a battery cell of the present embodiment may pressurize a battery cell 100 disposed between a first pressurizing portion 20a and a second pressurizing portion 20b. During this process, if the second plate 40 pressurizes the gas chamber 208 before the first plate 30 pressurizes the accommodation portion 204, the opening P of the case 110 will be blocked by the second plate 40, making it difficult for air inside the case 110 to escape to the outside thereof.

Therefore, the pressurizing portion 20 of the present embodiment may be configured so that the first plate 30 pressurizes the accommodation portion 204 first, and then the second plate 40 pressurizes the gas chamber 208.

To this end, the pressurizing portion 20 of the present embodiment may be formed such that a gap S2 (hereinafter referred to as a second gap) between the first plates 30 are greater than a gap S1 (hereinafter referred to as a first gap) between the second plates 40, based on the contact surface that contacts the case 110 of the battery cell 100.

In the apparatus 1 for manufacturing a battery cell of the present embodiment, when the second plates 40 pressurize the gas chamber 208 and are in close contact therewith, air may be completely removed from the accommodation portion 204.

In an embodiment, the second plate 40 may be disposed to contact and pressurize the gas chamber 208 after the air within the accommodation portion 204 is completely removed.

Additionally, in an embodiment, the second plate 40 may be disposed to pressurize the gas chamber 208 by contacting the same while the air within the accommodation portion 204 is substantially removed. For example, the second plate 40 may contact the gas chamber 208 while approximately 10% of the air remains within the accommodation portion 204. In this case, when the second plate 40 pressurizes the gas chamber 208, the first plate 30 also additionally pressurizes the accommodation portion 204. Therefore, the remaining air within the accommodation portion 204 may be removed during the process of pressurizing the gas chamber 208 by the second plate 40.

To ensure that the second plate 40 firmly pressurizes the gas chamber 208, an elastic member 42, such as a rubber plate, may be disposed on the surface of the second plate 40 that contacts the gas chamber 208.

Meanwhile, if the type of battery cell 100 being manufactured changes, the thickness of the accommodation portion 204 or the gas chamber 208 may also change. Therefore, in such cases, the first gap S1 and the second gap S2 need to be adjusted appropriately for the battery cell 100.

In response, at least one of the first pressurizing portion 20a and the second pressurizing portion 20b may include a position adjusting portion 50 connecting the first plate 30 and the second plate 40. The position adjusting portion 50 may adjust the protrusion distance of the second plate 40 relative to the first plate 30.

The position adjusting portion 50 is the portion connecting the first plate 30 and the second plate 40 of the second pressurizing portion 20b and may adjust the contact surface position of the second plate 40 based on the pressing direction as the first direction described above.

In an embodiment, the position adjusting portion 50 may include a first bracket 51 extending from the first plate 30, a shaft 59 rotatably coupled to the first bracket 51, and a second bracket 52 extending from the second plate 40 and coupled to the shaft 59.

Furthermore, the position adjusting portion 50 may further include an adjustment member 54 disposed to protrude from the first bracket 51 toward the second plate 40 and support the second plate 40.

The first bracket 51 may be fastened to the first plate 30 and may extend outwardly of the first plate 30.

The second bracket 52 may be fastened to the second plate 40 and may be connected to the outside of the second plate 40 and coupled to the first bracket 51.

Both the first bracket 51 and the second bracket 52 may be fastened to surfaces other than the contact surfaces of the first plate 30 and the second plate 40.

One end of the first bracket 51 may be fastened to the back surface of the first plate 30, and a shaft 59 may be coupled to the other end of the first bracket 51. In this case, the back surface of the first plate 30 may refer to the surface opposite the contact surface of the first plate 30.

The first bracket 51 may extend from the first plate 30 in a third direction. In this case, the third direction may refer to a direction orthogonal to the first direction, and may refer to the direction in which the gas chamber 208 is disposed relative to the accommodation portion 204. Referring to FIG. 5, the third direction may be the Z-axis direction.

The shaft 59 may be coupled to the upper end of the first bracket 51. The shaft 59 may be coupled to the first bracket 51 to be rotatable about the longitudinal center thereof as the rotational axis. To this end, the first bracket 51 may be coupled to both ends of the shaft 59. For smooth rotation of the shaft 59, both ends of the shaft 59 may be coupled to the first bracket 51 via bearings, but the present embodiment is not limited thereto.

The shaft 59 may be coupled to the first bracket 51 by being disposed in a second direction whose axial direction is parallel to the surface direction of the second plate 40. In this case, the second direction may be a direction orthogonal to the first direction and the third direction, and may be the Y-axis direction parallel to the floor surface.

A second bracket 52 may be coupled to the shaft 59. To this end, the second bracket 52 includes an insertion groove 57 into which the shaft 59 is inserted. The depth of the insertion groove 57 may be formed to be greater than the diameter of the shaft 59.

One end of the second bracket 52 may be fastened to the back surface of the second plate 40, and the other end thereof may be coupled to the shaft 59. Therefore, the insertion groove 57 may be formed at the other end of the second bracket 52. In this case, the back surface of the second plate 40 may refer to the surface opposite the contact surface of the second plate 40.

The insertion groove 57 may be formed to have a depth orthogonal to the surface direction of the first plate 30 and may be formed to be deeper than the diameter of the shaft 59.

The second bracket 52 may be fastened to the shaft 59 via a fastening member 58, such as a screw or bolt. The fastening member 58 may be fastened to the shaft 59 by having an end that penetrates the second bracket 52. Accordingly, when the shaft 59 rotates, the second bracket 52 and the second plate 40 may rotate together with the shaft 59 using the shaft 59 as the axis of rotation.

The second pressurizing portion 20b of the present embodiment may adjust the position of the second plate 40 by adjusting the position of the shaft 59 inserted into the insertion groove 57.

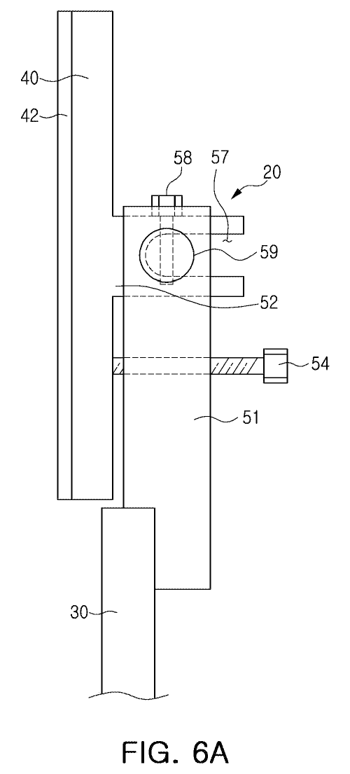

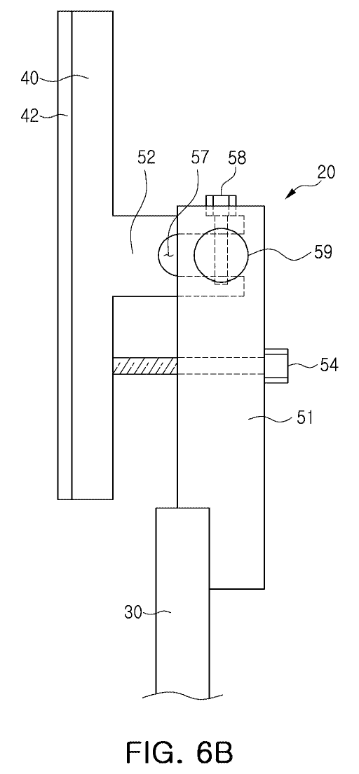

FIGS. 6A and 6B are drawings illustrating how the position of the second plate is adjusted in the pressurizing portion illustrated in FIG. 4. As illustrated in FIG. 6A, when the shaft 59 is disposed as deeply as possible into the insertion groove 57 and coupled to the second bracket 52, the second plate 40 may be disposed as far as possible from the gas chamber 208. Conversely, as illustrated in FIG. 6B, when the shaft 59 is disposed close to the entrance of the insertion groove 57 and coupled to the second bracket 52, the second plate 40 may be positioned close to the gas chamber 208.

Therefore, the operator may adjust the degree to which the shaft 59 is inserted into the insertion groove 57 according to the size and shape of the battery cell 100, and then fasten the second bracket 52 to the shaft 59.

Meanwhile, the second plate 40 is coupled to the shaft 59 via the second bracket 52, and may thus rotate due to gravity. In this case, the contact surface of the second plate 40 may not remain parallel to the other opposing second plate 40. Therefore, the position adjusting portion 50 of the present embodiment may include an adjustment member 54 to position the pair of second plates 40 in parallel.

The adjustment member 54 supports the back surface of the second plate 40 to position the second plate 40 in parallel with the gas chamber 208. In this case, the bear surface of the second plate 40 may refer to the opposite surface of the contact surface.

The adjustment member 54 may be coupled to the first bracket 51 and at least a portion thereof may protrude toward the second plate 40 to contact the second plate 40. The adjustment member 54 is screw-coupled to the first bracket 51, below the shaft 59, and the protrusion distance thereof from the first bracket may be adjusted by rotating the screw.

In an embodiment, the adjustment member 54 may be coupled to the first bracket 51 while penetrating therethrough in the first direction and may be screw-coupled to the first bracket 51 using a bolt or screw. Therefore, the operator may rotate the adjustment member 54 to move the adjustment member 54 in the first direction, thereby adjusting the distance at which the adjustment member 54 protrudes from the second bracket 52.

In this embodiment, both the first pressurizing portion 20a and the second pressurizing portion 20b may include the position adjusting portion 50. However, the present disclosure is not limited thereto, and either the first pressurizing portion 20a or the second pressurizing portion 20b may include the position adjusting portion 50. In this case, the other one thereof is provided such that the second plate 40 may be directly fastened to the first plate 30.

The heating unit 70 may include a pair of heating blocks 71 positioned on both sides of the opening P of the battery cell 100, respectively, to heat pressurize the outer casing. The pair of heating blocks 71 may seal the outer casing by thermally pressurizing the portion of the outer casing where the opening P is formed. To this end, each heating block 71 may be disposed such that one surface faces the battery cell 100 and may be disposed such that it may reciprocate toward the battery cell 100. In an embodiment, the heating block 71 may be formed such that one surface faces a portion corresponding to the opening P of the outer casing. In this embodiment, the opening P is formed at the upper end of the outer casing as illustrated in FIG. 4. Therefore, the heating block 71 may be disposed along the upper end of the outer casing.

A pair of heating blocks 71 may be positioned line-symmetrically relative to the outer casing, and may be placed in close contact with each other to heat and pressurize the outer casing. To this end, each heating block 71 may be equipped with a heater, such as a heating wire.

As the heating blocks 71 heat and pressurize the outer casing, the opening P of the outer casing may be thermally fused and joined, thereby sealing the accommodation portion 204 and the gas chamber 208.

Next, the process of sealing a battery cell 100 using the apparatus 1 for manufacturing a battery cell of the present embodiment will be described.

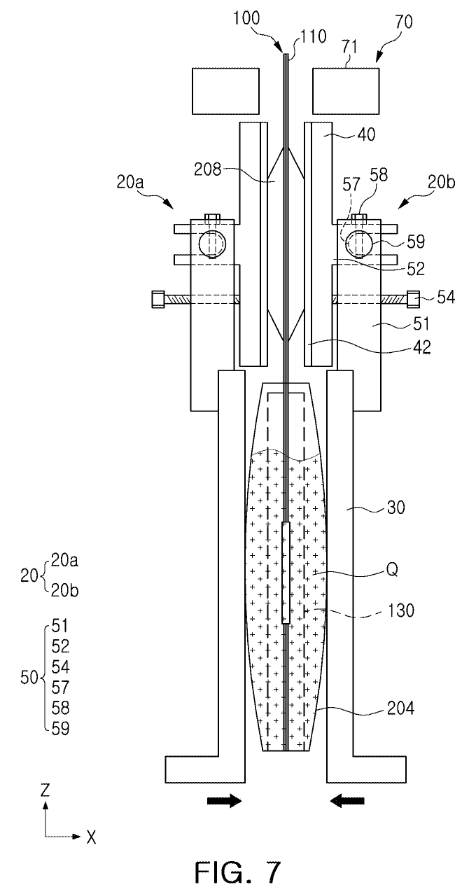

FIGS. 7 to 9 illustrate the process of sealing a battery cell using the apparatus for manufacturing a battery cell illustrated in FIG. 4.

As described above, the apparatus 1 for manufacturing a battery cell of the present embodiment may be used in the second sealing process of sealing the opening P. Therefore, as illustrated in FIG. 4, a process of disposing a pouch-shaped case 110 in which an electrode assembly 130 and an electrolyte Q are inserted between the first pressurizing portion 20a and the second pressurizing portion 20b may be performed first.

Next, as illustrated in FIG. 7, an operation of moving the first pressurizing portion 20a and the second pressurizing portion 20b toward the battery cell 100 to pressurize the accommodation portion 204 of the battery cell 100 may be performed.

In the present embodiment, when the first pressurizing portion 20a and the second pressurizing portion 20b move toward the battery cell 100, the first plate 30 may contact the battery cell 100 prior to the second plate 40. Accordingly, the first plates 30 of the pressurizing portion 20 may first contact both surfaces of the accommodation portion 204 and then pressurize the accommodation portion 204. As both surfaces of the accommodation portion 204 are pressurized, the internal space of the accommodation portion 204 may decrease in volume, and accordingly, the electrolyte Q may overall fill the internal space of the accommodation portion 204.

In this operation, the second plates 40 do not contact the gas chamber 208 or the outer casing, and thus, the air inside the accommodation portion 204 may be discharged to the outside through the opening P formed at the top of the outer casing.

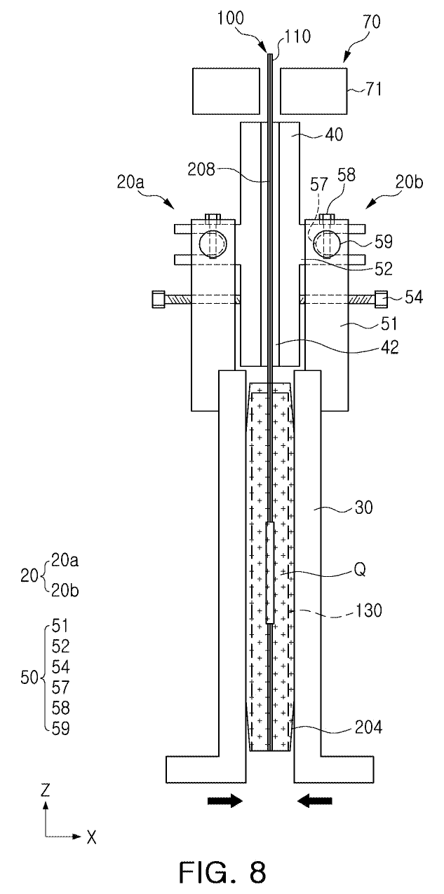

Next, as illustrated in FIG. 8, an operation of continuously moving the first pressurizing portion 20a and the second pressurizing portion 20b toward the electrode assembly 130 to pressurize the gas chamber 208 of the battery cell 100 may be performed.

In this operation, the first plates 30 may further pressurize both surfaces of the accommodation portion 204. Therefore, any air remaining within the accommodation portion 204 may move into the gas chamber 208, and in some cases, a portion of the electrolyte Q may also move into the gas chamber 208.

Furthermore, in this operation, the second plates 40 of the pressurizing portion 20 may contact both surfaces of the gas chamber 208, thereby pressurizing the gas chamber 208. The second plates 40 may pressurize the gas chamber 208 by closely contacting each other, allowing air in the gas chamber 208 to be discharged to the outside through the opening P formed at the top of the outer casing.

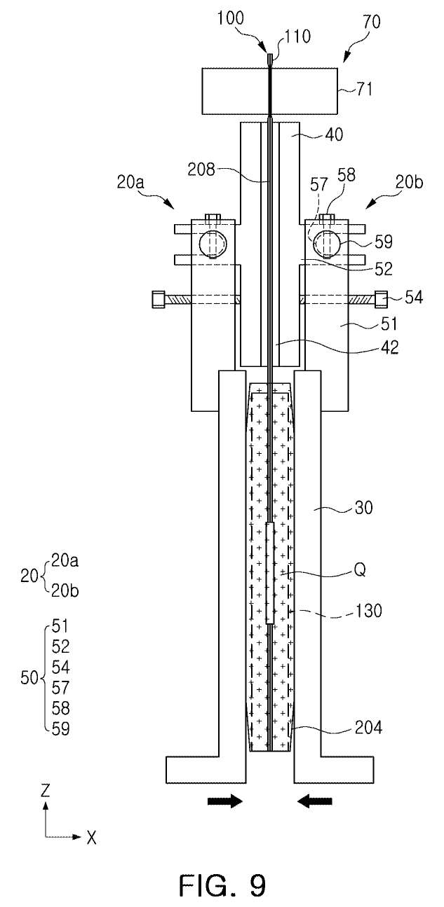

Next, as illustrated in FIG. 9, an operation of sealing the outer casing using a heating unit 70 may be performed, thereby completing the second sealing process described above.

The heating blocks 71 may heat-pressurize the outer casing while closely contacting each other. The area of the outer casing in contact with the heating blocks 71 is thermally fused, sealing the opening P.

The apparatus 1 for manufacturing a battery cell in the present embodiment described above does not require the battery cell 100 to be placed in a vacuum chamber to remove air from within the battery cell 100 during the second sealing process, thereby significantly reducing the equipment required for the second sealing process.

Furthermore, since the process of disposing or removing the battery cell 100 from within the vacuum chamber may be omitted, process time may be shortened.

Below, embodiments will be further described with reference to detailed experimental examples. The examples and comparative examples included in the experimental examples are merely illustrative of the present disclosure and do not limit the scope of the appended claims. It will be apparent to those skilled in the art that various modifications and variations to the examples are possible within the scope and technical spirit of the present disclosure, and such modifications and variations are also within the scope of the appended claims.

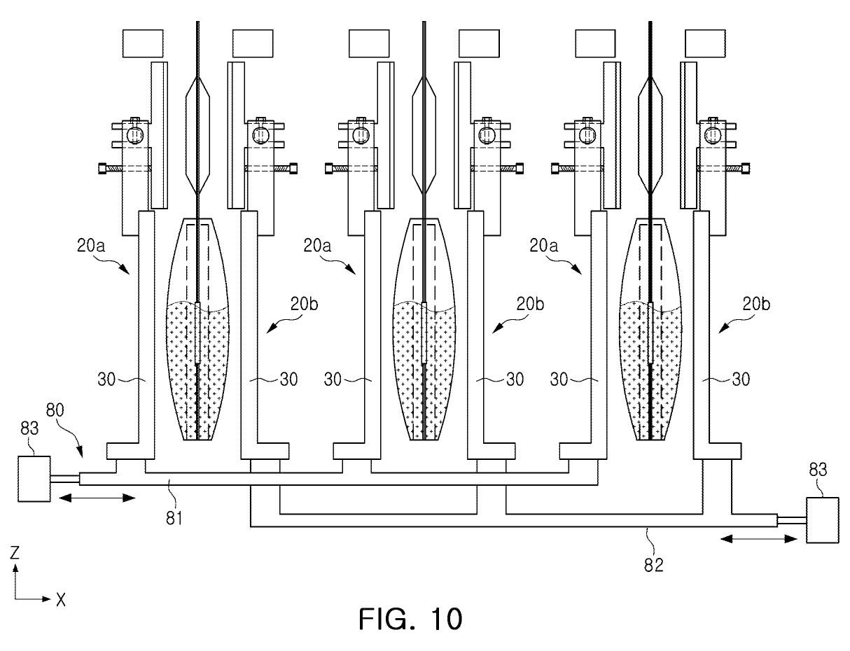

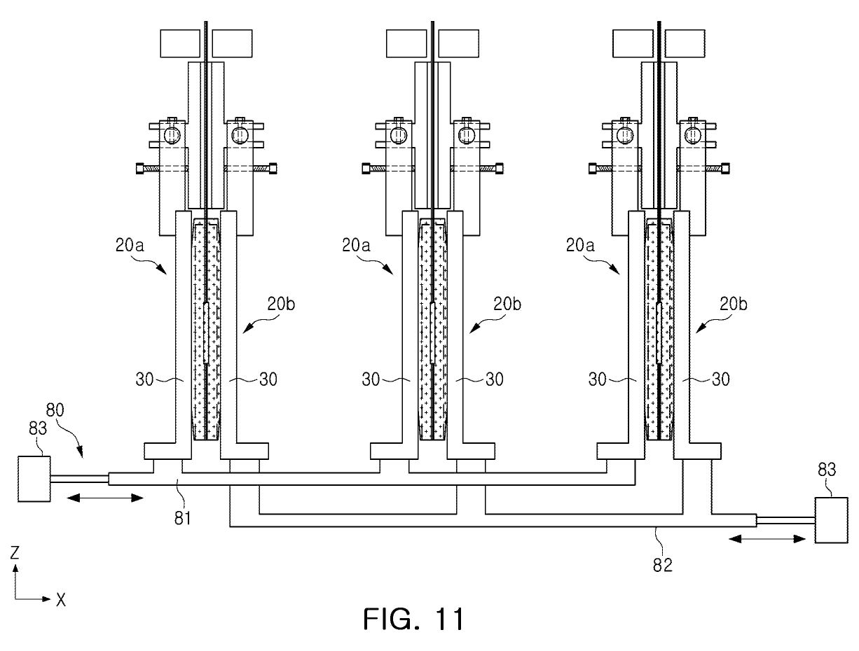

FIGS. 10 and 11 illustrate an apparatus for manufacturing a battery cell according to another embodiment. FIG. 11 illustrates a state in which the apparatus for manufacturing a battery cell of FIG. 10 pressurizes a battery cell 100.

Referring to FIGS. 10 and 11, the apparatus 1 for manufacturing a battery cell in the present embodiment may include a plurality of pressurizing portions 20 of the aforementioned embodiment disposed in parallel, and a moving portion 80 that moves the plurality of pressurizing portions 20 together.

The moving portion 80 may include a first frame 81 coupled to a plurality of first pressurizing portions 20a, a second frame 82 coupled to a plurality of second pressurizing portions 20b, and a power device 83 that reciprocally moves the first frame 81 and the second frame 82.

The first frame 81 and the second frame 82 may be coupled to the lower end of the pressurizing portion 20. For example, the plurality of first pressurizing portions 20a may be provided such that the lower surfaces of the first plates 30 are fastened to the first frame 81, and the plurality of second pressurizing portions 20b may be provided such that the lower surfaces of the first plates 30 are fastened to the second frame 82. Therefore, when the first frame 81 moves linearly, the plurality of first plates 30 may also move linearly. Similarly, when the second frame 82 moves linearly, the plurality of second plates 40 may also move linearly.

Although not illustrated, rails may be disposed at the lower portions of the first frame 81 and the second frame 82, respectively. In this case, the first frame 81 and the second frame 82 may slide along the rails.

The power device 83 may reciprocate the first frame 81 and the second frame 82 in the first direction. In the present embodiment, the power device 83 may include a first power device that moves the first frame 81 and a second power device that moves the second frame 82. However, the present disclosure is not limited thereto, and, if necessary, the first frame 81 and the second frame 82 may be configured to move together using a single power device 83.

The power device 83 may be a rotary motor, a linear motor, or a hydraulic/pneumatic cylinder, but the present embodiment is not limited thereto.

The apparatus for manufacturing a battery cell according to the present embodiment described above may operate multiple pressurizing portions simultaneously, thereby increasing the battery cell manufacturing yield.

As set forth above, according to an embodiment, the sealing process eliminates the need to place the battery cell in a vacuum chamber to remove air within the battery cell, thereby significantly reducing the equipment required for the sealing process. Furthermore, the process of disposing or removing the battery cell in or from the vacuum chamber may be omitted, thereby reducing the process time.

Only specific examples of implementations of certain embodiments are described. Variations, improvements and enhancements of the disclosed embodiments and other embodiments may be made based on the disclosure of this patent document.

For example, the above-described embodiments may be implemented by deleting some of the components, and the embodiments may be implemented in combination with each other.

What is claimed is:

1. An apparatus for manufacturing a battery cell in which an electrode assembly is inserted into an outer casing in a pouch form having an opening formed therein, the apparatus comprising:
a pressurizing portion disposed on both sides of the battery cell and pressurizing the battery cell; and
a heating unit disposed on both sides of the battery cell and sealing the opening of the outer casing,
wherein the pressurizing portion includes,
a first pressurizing portion disposed on one side of the battery cell and a second pressurizing portion disposed on the other side of the battery cell,
wherein each of the first pressurizing portion and the second pressurizing portion includes,
a first plate configured to pressurize an accommodation portion in which an electrode assembly is accommodated in the battery cell; and
a second plate configured to pressurize a gas chamber in which gas is accommodated in the battery cell.

2. The apparatus of claim 1, wherein the first plate and the second plate are interconnected and move together.

3. The apparatus of claim 1, wherein each of the first pressurizing portion and the second pressurizing portion is disposed such that the second plate protrudes further toward the battery cell than the first plate.

4. The apparatus of claim 3, wherein at least one of the first pressurizing portion and the second pressurizing portion includes a position adjusting portion connecting the first plate and the second plate,
wherein the position adjusting portion adjusts a protrusion distance of the second plate, relative to the first plate.

5. The apparatus of claim 4, wherein the position adjusting portion includes,
a first bracket extending from the first plate;
a shaft rotatably coupled to the first bracket; and
a second bracket extending from the second plate and coupled to the shaft.

6. The apparatus of claim 5, wherein the second bracket includes an insertion groove into which the shaft is inserted,
wherein a depth of the insertion groove is configured to be greater than a diameter of the shaft.

7. The apparatus of claim 6, further comprising an adjustment member disposed to protrude from the first bracket toward the second plate and supporting the second plate.

8. The apparatus of claim 7, wherein the adjustment member is screw-coupled to the first bracket, below the shaft, and a protrusion distance thereof from the first bracket is adjusted by screw rotation.

9. The apparatus of claim 1, wherein each of the first pressurizing portion and the second pressurizing portion is configured such that, when moving toward the battery cell, the first plate contacts the battery cell prior to the second plate.

10. The apparatus of claim 1, wherein the heating unit includes a pair of heating blocks positioned on both sides of an opening of the battery cell, respectively, and configured to heat pressurize the outer casing.

11. The apparatus of claim 9, wherein the pressurizing portion is provided as a plurality of pressurizing portions positioned in parallel,
wherein the apparatus further includes a moving portion moving the plurality of pressurizing portions together.

12. The apparatus of claim 1, wherein the moving portion includes,
a first frame coupled to a plurality of first pressurizing portions;
a second frame coupled to a plurality of second pressurizing portions; and
a power device reciprocally moving the first frame and the second frame.
